(19) United States
(12) Patent Application Publication
(10) Pub. No.: US 2025/0335620 A1
(43) Pub. Date: Oct. 30, 2025

(54) ACCESS CONTROL TO PROPRIETARY DATA USING TOKENS

(71) Applicant: RiEightHundredIP Limited, Singapore (SG)

(72) Inventors: Adam Jason Levinson, Singapore (SG); Tarek Chaker Mustapha, Chino Hills, CA (US); Yonatan H. Hagos, Los Angeles, CA (US)

(21) Appl. No.: 19/187,675

(22) Filed: Apr. 23, 2025

Related U.S. Application Data
(63) Continuation of application No. PCT/US2025/025845, filed on Apr. 22, 2025.
(60) Provisional application No. 63/638,260, filed on Apr. 24, 2024.

(51) Int. Cl. G06F 21/62; G06F 21/10; G06F 21/60

(52) U.S. Cl. CPC G06F 21/6218; G06F 21/1014; G06F 21/108; G06F 21/602

(57) ABSTRACT

Techniques for enabling tokenizing non-physical elements of physical assets using non-fungible tokens (NFTs) to enable independent management, appraisal, and transfer. The blockchain-based platform utilizes smart contracts for creating and managing NFTs, with secure access control for authorized interactions and a user-friendly interface for managing tokenized assets.

### CROSS-REFERENCE

This application is a bypass continuation of PCT/US25/25845, filed on Apr. 22, 2025 which claims priority to U.S. Patent Application No. 63/638,260, filed Apr. 24, 2024, the contents of which are fully incorporated by reference.

### TECHNICAL FIELD

This description generally relates to the field of digital asset management, and more specifically, to the tokenization of non-physical elements of physical assets using non-fungible tokens (NFTs).

### BACKGROUND

Non-fungible tokens (NFTs) are digital assets distinct from cryptocurrencies like Bitcoin or Ethereum, representing both tangible and intangible items. NFTs have unique digital signatures confirming authenticity and ownership, enabling trading similar to physical assets. Physical assets, such as real estate, often encompass non-physical elements like architectural plans and appliance specifications. These non-physical elements, typically transferred with the physical asset, present an opportunity for tokenization through NFTs. However, there exists a need to streamline the management and transfer of these non-physical elements independently of the physical asset, as well as to facilitate efficient visualization and interaction with such digital assets.

Further, conventional systems lack robust mechanisms for delineating the boundaries of such non-physical elements, verifying rights of access, or managing partial transfer scenarios. These limitations may hinder flexible ownership models, limit licensing potential, and complicate value assessment in digital marketplaces. There remains a need for improved frameworks that can address these challenges without tightly coupling non-physical content to the underlying physical asset. Additionally, existing platforms often lack the ability to modularize or reassign ownership of individual non-physical components without significant technical overhead or reliance on centralized intermediaries.

### SUMMARY

The present invention pertains to the tokenization of non-physical elements associated with physical assets, such as real estate properties, enabling distinct ownership and transfer of the non-physical elements independently of the physical asset, with features including access control and visualization representations.

Methods, systems, and articles of manufacture, including computer program products, are provided for a method for generating a token on a blockchain, the method comprising: causing an execution of one or more functions of a smart contract, wherein the smart contract is associated with a first token of the blockchain, wherein the first token comprises data associating the first token with: a first data element corresponding to a first non-physical element of a physical asset, a first visualization corresponding to the first data element; a second data element corresponding to a second non-physical element of the physical asset, and a second visualization corresponding to the second data element; wherein the execution of the one or more functions of the smart contract causes: the generation of a second token of the blockchain, the second token comprising data associating the second token with the second data element corresponding to the second non-physical element of the physical asset and the second visualization corresponding to the second data element; and the generation of data detaching the association of the first token with the second data element corresponding to the second non-physical element of the physical asset and the second visualization corresponding to the second data element.

In some variations, the first token includes at least one metadata field comprising a URI (uniform resource indicator) referencing the first data element corresponding to the first non-physical element of the physical asset.

In some variations, the first token includes at least one metadata field comprising a URI (uniform resource indicator) referencing the first visualization corresponding to the first data element.

In some variations, the generated data detaching the association of the first token with the second data element and the second visualization is added to a block of the blockchain.

In some variations, the method further comprises causing the second token to be transferred to a wallet address of the blockchain different from the wallet address possessing the first token.

In another aspect, there provided a method of controlling access to one or more data elements associated with a token on a blockchain, the method comprising: receiving a request to access data representing a non-physical element of a physical asset; identifying, on the blockchain, a token comprising an association with the data representing the non-physical element of the physical asset; identifying a public cryptographic key of an entity that made the request; using the public cryptographic key to verify that the entity that made the request possesses the token; and granting access to the data representing the non-physical element of the physical asset.

In some variations, using the public cryptographic key to verify that the entity that made the request possesses the token comprises: identifying a wallet address that possesses the token, and using the public cryptographic key to verify a digital signature associated with the wallet address.

In another aspect, there provided a method of managing data elements on a blockchain, the method comprising providing a first user interface of a first token, wherein the first token is associated with a collection of data elements, and wherein the first user interface represents the collection of data elements; in response to a detachment request from a user, detaching a data element from the first token to generate a second token associated with the detached data element; updating, upon a transfer of ownership of the second token, metadata associated with the first token to restrict access to the detached data element; and updating the first user interface of the first token to reflect the detachment of the data element from the first token.

In some variations, the updated first user interface comprises a representation of the detached data element without allowing access to the detached data element.

In some variations, the detaching the data element from the first token further comprises verifying that the user who made the detachment request possesses the first token associated with the collection of the data elements.

In some variations, the method further comprising updating the metadata associated with the first token to reflect the transfer of ownership of the second token and the detached data element; and providing a second user interface of the detached data element to an entity that processes the second token after the transfer.

In some variations, in response to an additional detachment request from the user, detaching an additional data element from the collection of the data elements to generate a third token associated with the additional detached data element.

In some variations, the first token and the second token are non-fungible tokens.

In some variations, the metadata associated with the first token comprises an upper limit for a number of the data elements that are detachable, wherein the upper limit is configurable.

In some variations, the metadata associated with the first token comprises a title, and wherein the title is indicative of the data elements that are currently associated with the first token.

In some variations, updating the first user interface of the first token further comprises updating the title to reflect the detachment of the data element from the first token.

In some variations, the title does not include a representation of non-detachable data elements.

In another aspect, there provided a computer program product for generating a token on a blockchain comprising a non-transitory machine-readable medium storing instructions that, when executed by at least one programmable processor, cause the at least one programmable processor to perform operations comprising: causing an execution of one or more functions of a smart contract, wherein the smart contract is associated with a first token of the blockchain, wherein the first token comprises data associating the first token with: a first data element corresponding to a first non-physical element of a physical asset, a first visualization corresponding to the first data element; a second data element corresponding to a second non-physical element of the physical asset, and a second visualization corresponding to the second data element; wherein the execution of the one or more functions of the smart contract causes: the generation of a second token of the blockchain, the second token comprising data associating the second token with the second data element corresponding to the second non-physical element of the physical asset and the second visualization corresponding to the second data element; and the generation of data detaching the association of the first token with the second data element corresponding to the second non-physical element of the physical asset and the second visualization corresponding to the second data element.

In another aspect, there provided a computer program product of controlling access to one or more data elements associated with a token on a blockchain comprising a non-transitory machine-readable medium storing instructions that, when executed by at least one programmable processor, cause the at least one programmable processor to perform operations comprising: receiving a request to access data representing a non-physical element of a physical asset; identifying, on the blockchain, a token comprising an association with the data representing the non-physical element of the physical asset; identifying a public cryptographic key of an entity that made the request; using the public cryptographic key to verify that the entity that made the request possesses the token; and granting access to the data representing the non-physical element of the physical asset.

In another aspect, there provided a computer program product of managing data elements on a blockchain comprising a non-transitory machine-readable medium storing instructions that, when executed by at least one programmable processor, cause the at least one programmable processor to perform operations comprising: providing a first user interface of a first token, wherein the first token is associated with a collection of data elements, and wherein the first user interface represents the collection of data elements; in response to a detachment request from a user, detaching a data element from the first token to generate a second token associated with the detached data element; updating, upon a transfer of ownership of the second token, metadata associated with the first token to restrict access to the detached data element; and updating the first user interface of the first token to reflect the detachment of the data element from the first token.

In another aspect, there provided is a system for generating a token on a blockchain comprising: at least one programmable processor; and a non-transient machine-readable medium storing instructions that, when executed by the processor, cause the at least one programmable processor to perform operations comprising: causing an execution of one or more functions of a smart contract, wherein the smart contract is associated with a first token of the blockchain, wherein the first token comprises data associating the first token with: a first data element corresponding to a first non-physical element of a physical asset, a first visualization corresponding to the first data element; a second data element corresponding to a second non-physical element of the physical asset, and a second visualization corresponding to the second data element; wherein the execution of the one or more functions of the smart contract causes: the generation of a second token of the blockchain, the second token comprising data associating the second token with the second data element corresponding to the second non-physical element of the physical asset and the second visualization corresponding to the second data element; and the generation of data detaching the association of the first token with the second data element corresponding to the second non-physical element of the physical asset and the second visualization corresponding to the second data element.

In another aspect, there provided is a system of controlling access to one or more data elements associated with a token on a blockchain comprising: at least one programmable processor; and a non-transient machine-readable medium storing instructions that, when executed by the processor, cause the at least one programmable processor to perform operations comprising: receiving a request to access data representing a non-physical element of a physical asset; identifying, on the blockchain, a token comprising an association with the data representing the non-physical element of the physical asset; identifying a public cryptographic key of an entity that made the request; using the public cryptographic key to verify that the entity that made the request possesses the token; and granting access to the data representing the non-physical element of the physical asset.

In another aspect, there provided is a system managing data elements on a blockchain comprising: at least one programmable processor; and a non-transient machine-readable medium storing instructions that, when executed by the processor, cause the at least one programmable processor to perform operations comprising: providing a first user interface of a first token, wherein the first token is associated with a collection of data elements, and wherein the first user interface represents the collection of data elements; in response to a detachment request from a user, detaching a data element from the first token to generate a second token associated with the detached data element; updating, upon a transfer of ownership of the second token, metadata associated with the first token to restrict access to the detached data element; and updating the first user interface of the first token to reflect the detachment of the data element from the first token.

In another aspect, there provided a method of managing access to a resource using token burn verification on a blockchain, the method comprising: receiving, from a client device, a request to access a resource associated with a token deployed on a blockchain; and verifying, based on blockchain transaction history, that a wallet address associated with the client device previously executed a burn operation of the token via a smart contract; in response to verifying the burn operation, granting access to the resource associated with the burned token.

In another aspect, there provided a computer program product of managing access to a resource using token burn verification on a blockchain comprising a non-transitory machine-readable medium storing instructions that, when executed by at least one programmable processor, cause the at least one programmable processor to perform operations comprising: receiving, from a client device, a request to access a resource associated with a token deployed on a blockchain; and verifying, based on blockchain transaction history, that a wallet address associated with the client device previously executed a burn operation of the token via a smart contract; in response to verifying the burn operation, granting access to the resource associated with the burned token.

In another aspect, there provided a system of managing access to a resource using token burn verification on a blockchain comprising: at least one programmable processor; and a non-transient machine-readable medium storing instructions that, when executed by the processor, cause the at least one programmable processor to perform operations comprising: receiving, from a client device, a request to access a resource associated with a token deployed on a blockchain; and verifying, based on blockchain transaction history, that a wallet address associated with the client device previously executed a burn operation of the token via a smart contract; in response to verifying the burn operation, granting access to the resource associated with the burned token.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### BRIEF DESCRIPTION OF THE DRAWINGS

FIG. 1 is a diagram illustrating an example process 100 for generating a second token from a first token on a blockchain, in which a smart contract is executed to create the second token and update the association of the first token, in accordance with one or more embodiments of the approach described herein.

FIG. 2 is a diagram illustrating an example process 200 for controlling access to a non-physical element of a physical asset using blockchain-based verification of token possession, in accordance with one or more embodiments of the approach described herein.

FIG. 3 is a diagram illustrating an example process 300 for managing detachment of data elements through a user interface associated with a token, including the generation of a second token and the corresponding metadata and interface updates, in accordance with one or more embodiments of the approach described herein.

FIG. 4 is a diagram illustrating an exemplary system 400 for managing non-physical elements of a physical asset using a blockchain-based token detachment mechanism, in accordance with one or more embodiments of the approach described herein.

FIG. 5 depicts a block diagram illustrating a computing system consistent with implementations of the current subject matter.

### DETAILED DESCRIPTION

The present disclosure addresses the technical challenge of managing non-physical elements of a physical asset independently, which traditionally remain inseparable from the physical asset itself. For instance, in the context of real estate, elements such as architectural plans, interior designs, and branding assets are typically bundled with the property. This presents difficulties in appraising, selling, or transferring such non-physical elements, which may encompass intellectual property, design schematics, and branding elements, among others. The ability to manage these elements separately from the physical asset may provide benefits such as maximizing value, as individual components may fetch higher prices when transacted in specialized markets catering to niche interests, such as historical architectural plans or custom interior designs.

Furthermore, the present disclosure solves the technical problem of access control to these non-physical elements. The traditional systems lack a robust mechanism to ensure that access to tokenized non-physical elements is strictly controlled and granted to authorized entities while preventing unauthorized access. This is particularly relevant when considering licensing opportunities, where owners may wish to grant access to proprietary technology or brand names to multiple parties, creating revenue streams without relinquishing ownership of the physical asset. The disclosed methods and systems provide enhanced flexibility in asset management, allowing owners to retain control over the physical asset while independently monetizing its non-physical components.

In some embodiments, non-physical elements of a physical asset (e.g., a real estate property) can be tokenized in the form of an NFT (non-fungible token). Ownership of the NFT may therefore be distinct from ownership of the physical asset, though the NFT can be conveyed at the same time as the physical asset from one owner to another. For example, if the physical asset is a real estate property, the non-physical elements could include architectural drawings, furniture layouts, color schemes, appliance specifications, plumbing and electrical plans, and so on. In this way, the non-physical elements can be appraised and/or sold to another party independent of the physical asset. Further, in some examples, if the NFT embodies multiple non-physical elements, one or more of the non-physical elements can be separated out into its own NFT and transferred to another party independent of the original NFT. In the example scenario of a real estate property, the owner of the NFT could separate the architectural drawings into its own NFT and transfer that NFT (and thus the architectural plans) to another party. In some examples, any of these NFTs include access control features that authorize only the respective NFT owner (or designees of the owner) to access the underlying non-physical elements. Further, in some examples, any of these NFTs are associated with one or more visualizations that represent the underlying non-physical elements which can be displayed in publicly accessible venues such as an NFT exchange. Furthermore, in some examples, an owner's portal may be provided to the owner(s) of the NFT(s) with functionalities such as viewing, interacting with, and managing the ownership or transfer of the NFT(s).

The present disclosure relates to a system and method for the tokenization and management of intangible elements of tangible assets through the use of NFTs. The approach presented herein addresses the technical challenges involved in the delineation, valuation, sale, or conveyance of intangible components, such as intellectual property rights, design blueprints, and branding elements, from their tangible counterparts. This delineation proves to be of significant value in instances where these components hold distinct value or market appeal, independently from the tangible asset.

The present disclosure includes a blockchain-based framework that facilitates the creation of NFTs embodying the intangible components of a tangible asset. This framework comprises a smart contract system that enables the generation, administration, and transfer of said NFTs. Each NFT may be linked to metadata delineating the intangible component it signifies, including aspects such as its features, ownership, and usage rights. In some embodiments, this metadata may be dynamically updated to mirror any alterations in ownership or rights, thereby ensuring the NFT reflects the current status of the intangible elements.

In some embodiments, the system includes an access control mechanism using cryptographic keys to authenticate and authorize users, allowing the users to access or transfer NFTs. This mechanism ensures that intangible elements are accessible to authorized parties, for example, potential buyers or licensees, while preventing unauthorized access. This is especially relevant for licensing, where multiple parties may access or interact with the intangible component without owning the tangible asset.

In some embodiments, the system includes a user interface for interacting with the smart contract and managing NFTs. Through this interface, users may create new NFTs for their intangible components, transfer NFT ownership, and update associated metadata. The interface is intuitive, lowering the barrier for users new to blockchain technology and smart contracts.

In some embodiments, access to the non-physical elements may be governed by a portal interface that requires possession of a valid token for entry. The smart contract may record token ownership on-chain, while the front-end application may serve as the enforcement layer, verifying token ownership prior to revealing content or interaction options. For example, when a user accesses the portal using their crypto wallet, the front-end may query the blockchain for token possession and unlock access if the wallet holds the corresponding token. This architecture provides flexibility to implement time-based or conditional access at the interface level without altering the on-chain logic.

Alternatively or additionally, in some embodiments, access may be extended to multiple parties via additional access tokens. Each tokenized element may be linked to a smart contract that includes a list of authorized access token IDs, which may be issued at the time of NFT deployment or dynamically added later. For example, a detached architectural design NFT may include access logic allowing both the owner and a designated architectural firm to retrieve the design files, each identified via cryptographic keys tied to access tokens. This structure enables collaborative access models while preserving decentralized ownership control.

In some embodiments, a blockchain-based system features a smart contract for generating a first NFT that corresponds to a first non-physical element of a physical asset. The system further allows for the creation of a second NFT that corresponds to a second non-physical asset, enabling the management and transfer of multiple non-physical elements associated with a physical asset independently. In some embodiments, the smart contract may incorporate a verification mechanism using cryptographic keys to control access, ensuring that interactions with the NFT are restricted to authorized users. In some embodiments, the system may provide a user interface for the execution of smart contract functions, such as the creation, transfer, and updating of NFTs, along with the visualization of the non-physical elements they represent.

Additionally, the smart contract is capable of updating the metadata of an NFT, reflecting changes in ownership or usage rights. An integrated appraisal module may be included to assess the value of the non-physical element, and a marketplace interface is provided for users to list and transact NFTs securely.

In some embodiments, the smart contract logic may include gas-efficient design patterns, such as storage slot packing, minimized state variable writes, and use of events instead of mappings for certain retrieval functions. For example, detachment transactions may rely on emitting structured logs to record changes rather than updating deeply nested mappings, thereby reducing transaction costs. These optimizations allow the system to scale for assets with numerous non-physical components while maintaining economic feasibility for frequent token operations.

The disclosed methods and systems may enable the management and monetization of non-physical elements of tangible assets. By using blockchain technology's immutability and transparency, the disclosed methods and systems provide a secure and efficient way of managing these components, offering benefits like value maximization, access to specialized markets, and flexible asset management.

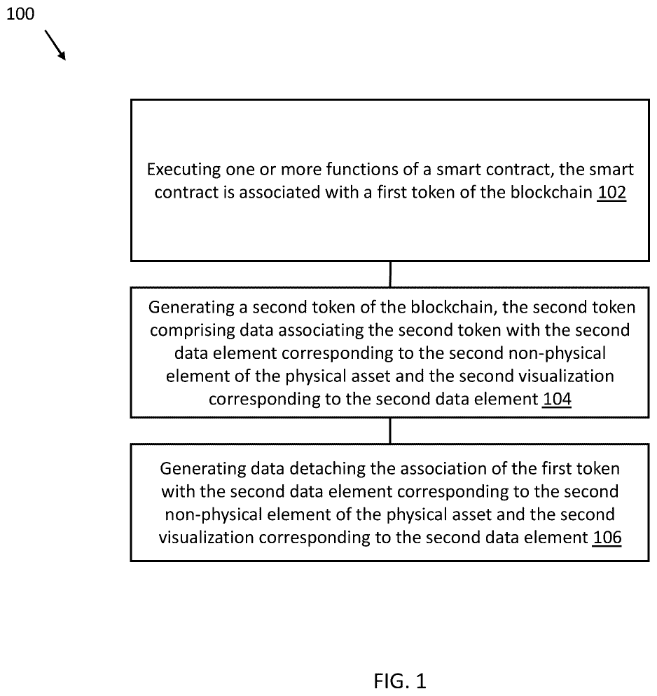

FIG. 1 is a diagram illustrating a flow chart of a process 100 for generating and managing tokenized representations of non-physical elements associated with a physical asset, in accordance with one or more embodiments of the approach described herein.

As shown in FIG. 1, the process 100 may begin with operation 102, wherein one or more functions of a smart contract are executed. The smart contract is associated with a first token stored on a blockchain. This first token may be linked to multiple non-physical elements of a given physical asset. For example, these non-physical elements may include architectural plans, branding designs, or appliance configurations. By structuring the token to encapsulate multiple data elements and their associated visualizations, the approach described herein enables a consolidated yet modular representation of intangible asset components, allowing for granular control over individual components. In some embodiments, the first token includes metadata fields that store Uniform Resource Identifiers (URIs), referencing either the underlying data elements or their visualizations. These metadata fields provide a flexible linking mechanism that supports decentralized storage and dynamic resolution.

The process may then proceed to operation 104, where the system generates a second token on the blockchain. The second token may contain data associating it with the second data element and a second visualization. The ability to issue a new, independent token corresponding to a discrete non-physical component enables fine-grained control, reuse, and monetization of individual content units. This supports scenarios where, for example, architectural designs may be sold or licensed independently of other asset components.

Following the generation of the second token, operation 106 involves detaching the association between the first token and the second data element, along with the second visualization. In some embodiments, this detachment is recorded as structured data, such as through the addition of a detachment record or update to metadata fields within a newly appended blockchain block. This record ensures immutability and traceability, while also ensuring that access to the detached element is no longer available via the original token.

In some embodiments, the second token may be transferred to a wallet address that is different from the wallet address holding the first token. This enables decentralized asset distribution, where different stakeholders may hold, trade, or license specific components of a larger intangible asset collection. Such independent transferability, backed by blockchain traceability, contributes to improved market efficiency, licensing flexibility, and novel digital ownership models.

Together, the operations illustrated in FIG. 1 provide a technical mechanism for detaching, reassigning, and independently managing discrete non-physical components of a physical asset. This allows for greater modularity, scalability, and configurability in tokenized digital asset frameworks.

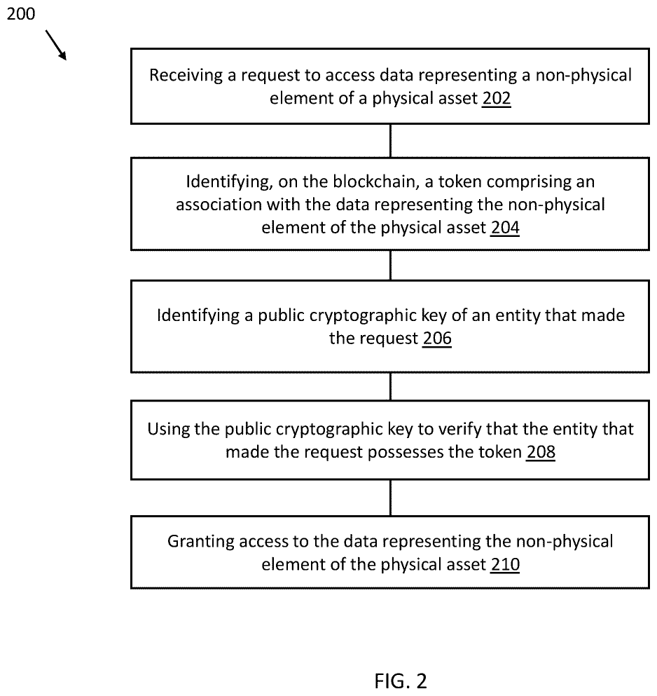

FIG. 2 is a diagram illustrating a flow chart of a process 200 for controlling access to non-physical elements associated with a physical asset using blockchain-based token verification, in accordance with one or more embodiments of the approach described herein.

As shown in FIG. 2, the process 200 may begin with operation 202, wherein the system receives a request to access data representing a non-physical element of a physical asset. This request may originate from a user, a system, or an application attempting to interact with protected digital content, such as architectural files or brand specifications.

In operation 204, the system identifies, on the blockchain, a token associated with the requested data. The token serves as a gatekeeper to the underlying digital content and may contain metadata linking it to one or more specific data elements. The linkage between token and content ensures that control over the token directly governs control over access to the associated content.

Next, in operation 206, the system identifies the public cryptographic key of the entity that initiated the access request. The key may be provided alongside the request or obtained through standard authentication channels.

In operation 208, the system uses the public key to verify that the requesting entity possesses the token. This may be achieved by identifying a wallet address associated with the token and validating a digital signature generated by the requester. By leveraging asymmetric cryptography and on-chain token ownership, this mechanism allows access to be granted without the need for traditional centralized access control systems.

In operation 210, upon successful verification, the system grants access to the requested non-physical element. The access may involve decryption of a URI, presentation of a visualization, or delivery of associated data, depending on the configuration of the token metadata and access policies.

This approach allows content access to be strictly and cryptographically limited to verified holders of the token, providing a decentralized and trustless access control mechanism. Such architecture offers a robust alternative to conventional authentication models, which often rely on off-chain databases and fragile permission systems. In contrast, the approach described herein leverages blockchain immutability and transparent token ownership to securely manage proprietary digital content.

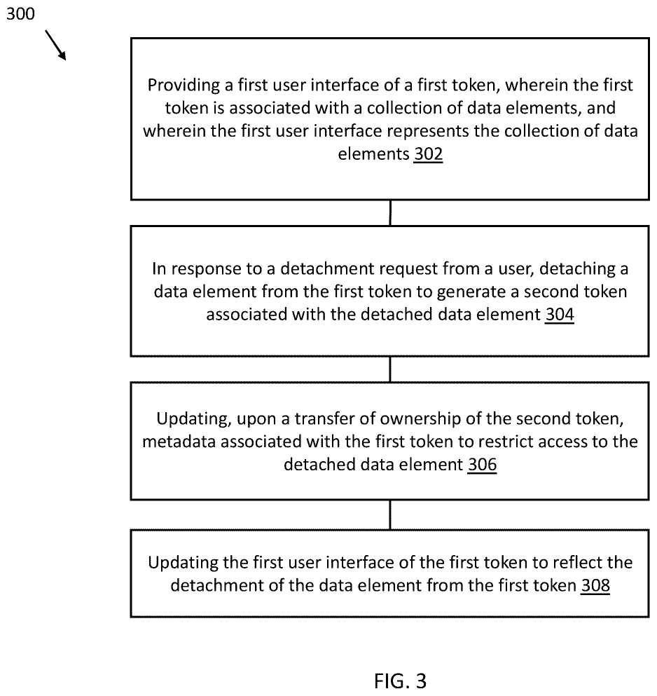

FIG. 3 is a diagram illustrating a flow chart of a process 300 for managing tokenized non-physical elements via a user interface, including interactive detachment and metadata updates, in accordance with one or more embodiments of the approach described herein.

As shown in FIG. 3, the process 300 may begin with operation 302, wherein the system provides a first user interface associated with a first token. The first token may be linked to a collection of data elements, each corresponding to a non-physical component of a physical asset. The user interface may visually represent this collection, for example by showing a modular view of architectural plans, visual branding, or configuration data associated with the token.

In operation 304, the system receives a detachment request from a user. The request identifies a specific data element to be separated from the first token. In some embodiments, the system may first verify that the requester possesses the token, for example by confirming wallet ownership through a digital signature check.

In operation 306, the system detaches the identified data element from the first token and generates a second token associated with the detached data element. The second token now represents an independently transferrable object on the blockchain. In some embodiments, the second token may be transferred to a different entity, and the metadata of the first token is accordingly updated to restrict access to the detached element.

In operation 308, the system updates the first user interface to reflect the detachment. For example, the visual representation of the detached data element may remain visible as a placeholder or grayed-out element, but access may be disabled to indicate the change in token association.

In some embodiments, the first token and the second token are implemented as non-fungible tokens (NFTs) following standardized protocols.

In some embodiments, the metadata associated with the first token may also be updated to reflect ownership changes, a list of remaining data elements, and other descriptive fields. The metadata may include a configurable upper limit on the number of elements that can be detached from the first token. In some embodiments, the metadata may include a configurable upper limit, for example as a numeric field or policy flag that governs the maximum number of detachable elements from the token. This limit may be set at creation time or modified through smart contract logic. In some implementations, the metadata may also include a title indicative of the token's current content or status, which is automatically updated when detachment occurs. For example, the title may be changed to remove reference to the detached component and reflect only those elements still associated with the token. In some embodiments, the title may omit non-detachable elements altogether. The title may be stored as a metadata field associated with the token and may reflect, for example, a list of retained data elements or a summary label. In some embodiments, the title may exclude identifiers or labels of non-detachable elements to avoid confusion in downstream access or valuation.

In some embodiments, the system may support repeated detachment actions from the same token. For example, a user may detach multiple elements over time, resulting in a collection of independently managed NFTs, each representing a different part of the original token's contents.

By combining real-time UI feedback with blockchain-backed updates and configurable metadata logic, the process illustrated in FIG. 3 enables token holders to manage digital asset composition in a transparent, interactive, and modular fashion. This improves both usability and control over tokenized representations of non-physical value.

In some embodiments, a burn-to-claim mechanism may be provided as a public-facing access control strategy, wherein a publicly distributed token must be irrevocably burned by a user in order to activate access privileges or claim benefits associated with the token. For example, a user may obtain an access token via a public call-to-action, such as a campaign, giveaway, or open mint. Upon acquiring the token, the user may navigate to a designated access portal and connect a wallet containing the token.

In response to a user-initiated claim request, the system may initiate a smart contract function that permanently burns the token—removing it from circulation—and records the burn event to the blockchain. The smart contract may optionally generate a soul bound token (SBT) associated with the user's wallet address, serving as an immutable credential indicating the user's prior participation. In some cases, the SBT may include metadata reflecting a timestamp of burn or visual styling to distinguish it from unburned variants.

In some embodiments, successful verification of the burn event triggers access enablement, such as decrypting a resource URI, activating a UI module, or unlocking a gated experience. This approach allows one-time token use for high-value, sensitive, or promotional access rights. The system may further enforce burn validation by scanning the blockchain for prior execution of a burn transaction associated with the token's smart contract address and confirming that the wallet requesting access corresponds to the one that executed the burn. In some examples, burned tokens may remain transferable or may be issued as soul bound tokens that cannot be transferred. In scenarios where post-burn privileges are meant to be identity-bound (e.g., exclusive membership, claimable benefits), soul bound tokens may be preferred. In other examples, the visual appearance of the token may change after burn to reflect redemption status, and such visual variants may be tracked in user interfaces as part of progress-based incentive systems.

Optionally, a Know Your Customer (KYC) verification process may be integrated into the burn flow. In such embodiments, users may be prompted to submit identity information as part of the token claim process. The system may store the KYC status in metadata fields associated with the resulting token or bind it to a session key for downstream access management.

In some embodiments, users may accumulate multiple burned access tokens over time. These tokens may be used as the basis for progressive access tiers or reward eligibility. For example, the system may determine a user's privilege level based on the number or type of soul bound tokens associated with their wallet address, thereby supporting cumulative benefits across different campaigns or product releases.

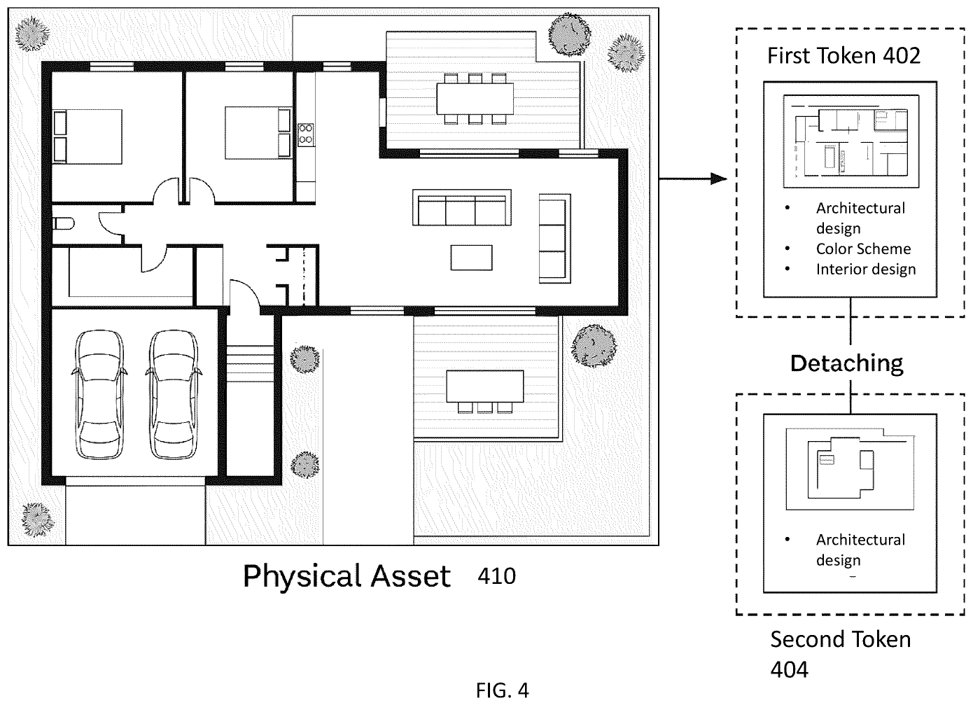

FIG. 4 is a diagram illustrating an example system 400 for managing tokenized representations of non-physical elements associated with a physical asset 410, in accordance with one or more embodiments of the approach described herein.

As shown in FIG. 4, a physical asset 410, such as a residential property, may be associated with a set of non-physical elements, including but not limited to architectural design, interior styling, and color schemes. These components may be encapsulated within a first token 402, which serves as a blockchain-anchored container for multiple digital representations corresponding to non-physical characteristics of the physical asset.

In some embodiments, the first token 402 may include structured metadata linking it to visual assets and descriptive files. These may be referenced by URI fields and displayed in a user interface as part of a token management portal. The first token 402 thus provides a unified yet decomposable digital representation of the intangible value components of the physical asset.

The system 400 may support a detachment operation, whereby one or more of the non-physical elements associated with the first token 402 may be separated and restructured into an independently managed token. For example, as illustrated in FIG. 4, the architectural design component is detached to form a new second token 404, leaving the remaining components (e.g., interior design, color scheme) within the first token.

In some embodiments, each non-physical element associated with the first token may be detached only once. The detachment may be recorded immutably on-chain, such that subsequent attempts to re-detach the same element are programmatically disallowed by the smart contract. This one-time detachment constraint may reflect an intentional design choice to ensure that detachment events represent irreversible and meaningful actions. For example, in a luxury real estate context, detaching the architectural design from a composite token may signify a permanent separation of design rights, reinforcing the gravity of the transaction.

In some embodiments, the detachment operation may be initiated through a user request submitted via a smart contract interface. Upon receiving the request, the system may verify that the requester possesses the first token 402, for example, by validating ownership via a public key and signature mechanism. Once verified, the system may:
Generate the second token 404;
Associate the second token 404 with the architectural design data;
Update the metadata of the first token 402 to reflect the removal of that data element;
Optionally restrict further access to the detached component via the first token.

In some embodiments, detachment may also result in a metadata record being written to the blockchain, recording the historical linkage and the detachment event. This record may include timestamps, digital signatures, or hashes of content to support auditability and digital provenance.

In some embodiments, once a data element has been detached and assigned to a second token, the system does not support re-merging the element back into the original token. This limitation may be by design to preserve the integrity of tokenized asset lineage.

Alternatively or additionally, in some implementations, the system may adopt a containerized NFT architecture that supports composability and structural re-association of previously detached tokens. For example, the system may leverage existing or emerging standards for nested or composable NFTs, such as ERC-7401 (Ethereum Request for Comment, ERC) or equivalent frameworks (e.g., future successors or domain-specific extensions) . . . . Under such architecture, the original token may act as an on-chain container, wherein one or more previously detached tokens may be re-associated by being transferred into the container. This containerized association may restore logical grouping among related non-physical elements, while preserving the independent transactional history and ownership records of each detached token. In some embodiments, metadata of the parent token may be dynamically updated to reflect current contents, such as by enumerating contained token identifiers or updating access descriptors accordingly.

The detached second token 404 may be transferred to a new wallet address, allowing a third party (e.g., architect, design firm, prospective buyer) to independently own, view, or license the detached content. In some embodiments, access to the architectural design data may be cryptographically restricted to the new token holder, with the smart contract enforcing visibility rights based on token possession.

This architecture enables a flexible, composable model of digital asset management, in which different components of a physical asset's intangible footprint can be independently valued, transacted, and governed. It provides not only ownership modularity but also supports granular access control, multi-party collaboration, and secondary licensing models-features not achievable under conventional token architectures.

### Example Computer System

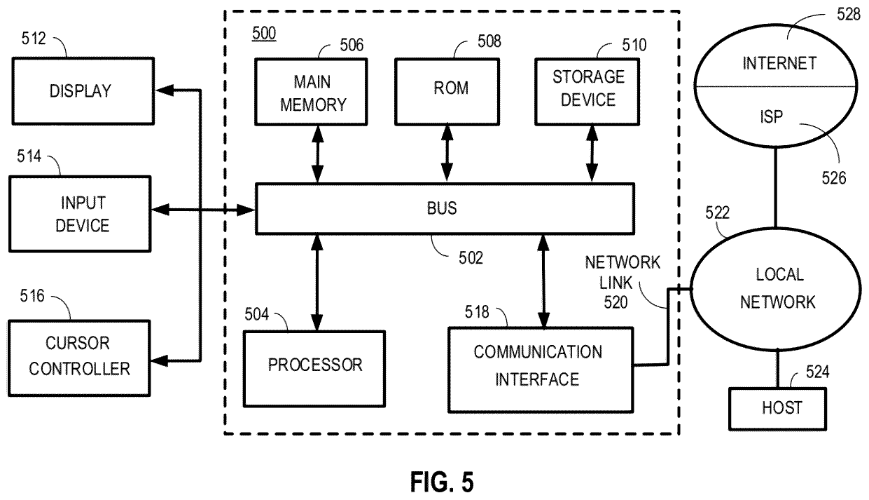

FIG. 5 illustrates an example computer system. In the implementation of FIG. 5, the computer system 500 is a special purpose computing device. The special-purpose computing device is hard-wired to execute blockchain protocols, includes digital electronic devices such as one or more application-specific integrated circuits (ASICs) or field programmable gate arrays (FPGAs) that are persistently programmed to perform the techniques herein, or includes one or more general purpose hardware processors programmed to perform the techniques pursuant to program instructions in firmware, memory, other storage, or a combination. In various implementations, the special-purpose computing devices are desktop computer systems, portable computer systems, handheld devices, network devices or any other device that incorporates both hard-wired or program logic to implement the techniques.

The computer system 500 includes a bus 502 or other communication mechanism for communicating information, and one or more computer hardware processors 504 coupled to the bus 502 for processing information. In some implementations, the hardware processors 504 are general-purpose microprocessors. The computer system 500 also includes a main memory 506, such as a random-access memory (RAM) or other dynamic storage device, coupled to the bus 502 for storing information and instructions to be executed by processors 504. In one implementation, the main memory 506 is used for storing temporary variables or other intermediate information during execution of instructions to be executed by the processors 504. Such instructions, when stored in non-transitory storage media accessible to the processors 504, render the computer system 500 into a special-purpose machine customized to perform the operations specified in the instructions.

In an implementation, the computer system 500 further includes a read only memory (ROM) 508 or other static storage device coupled to the bus 502 for storing static information and instructions for the processors 504. A storage device 512, such as a magnetic disk, optical disk, solid-state drive, or three-dimensional cross point memory is provided and coupled to the bus 502 for storing information and instructions.

In an implementation, the computer system 500 is coupled via the bus 502 to a display 510, such as a liquid crystal display (LCD), plasma display, light emitting diode (LED) display, or an organic light emitting diode (OLED) display for displaying information to a computer user. An input device 514, including alphanumeric and other keys, is coupled to bus 502 for communicating information and command selections to the processors 504. Another type of user input device is a cursor controller 516, such as a mouse, a trackball, a touch-enabled display, or cursor direction keys for communicating direction information and command selections to the processors 504 and for controlling cursor movement on the display 510.

According to one implementation, the techniques herein are performed by the computer system 500 in response to the processors 504 executing one or more sequences of one or more instructions contained in the main memory 506. Such instructions are read into the main memory 506 from another storage medium, such as the storage device 512. Execution of the sequences of instructions contained in the main memory 506 causes the processors 504 to perform the process steps described herein. In alternative implementations, hard-wired circuitry is used in place of or in combination with software instructions.

The term “storage media” as used herein refers to any non-transitory media that store both data or instructions that cause a machine to operate in a specific fashion. Such storage media includes both non-volatile media or volatile media. Non-volatile media includes, such as optical disks, magnetic disks, solid-state drives, or three-dimensional cross point memory, such as the storage device 512. Common forms of storage media include, such as a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge. Storage media is distinct from but is used in conjunction with transmission media. Transmission media participates in transferring information between storage media. Transmission media includes coaxial cables, copper wire and fiber optics, including the wires that include the bus 502.

In an implementation, various forms of media are involved in carrying one or more sequences of one or more instructions to the processors 504 for execution. The instructions are initially carried on a magnetic disk or solid-state drive of a remote computer. The remote computer loads the instructions into its dynamic memory and send the instructions over a telephone line using a modem. A modem local to the computer system 500 receives the data on the telephone line and use an infrared transmitter to convert the data to an infrared signal. An infrared detector receives the data carried in the infrared signal and appropriate circuitry places the data on the bus 502. The bus 502 carries the data to the main memory 506, from which processors 504 retrieves and executes the instructions. The instructions received by the main memory 506 are optionally stored on the storage device 512 either before or after execution by processors 504.

The computer system 500 also includes a communication interface 518 coupled to the bus 502. The communication interface 518 provides a two-way data communication coupling to a network link 520 connected to a local network 522. The communication interface 518 is an integrated service digital network (ISDN) card, cable modem, satellite modem, or a modem to provide a data communication connection to a corresponding type of telephone line. In another implementation, the communication interface 518 is a local area network (LAN) card to provide a data communication connection to a compatible LAN. In some implementations, wireless links are also implemented.

The network link 520 typically provides data communication through one or more networks to other data devices. The network link 520 provides a connection through the local network 522 to a host computer 524 or to a cloud data center or equipment operated by an Internet Service Provider (ISP) 526. The ISP 526 in turn provides data communication services through the world-wide packet data communication network now commonly referred to as the “Internet” 528. The local network 522 and Internet 528 both use electrical, electromagnetic or optical signals that carry digital data streams.

Any or all of the features and functions described above can be combined with each other, except to the extent it may be otherwise stated above or to the extent that any such implementation may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective implementations may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all implementations or that the features represented by such element may not be included in or combined with other elements in some implementations.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

In the foregoing description, implementations have been described with reference to numerous specific details that may vary from implementation to implementation. The description and drawings are, accordingly, to be regarded in an illustrative rather than a restrictive sense. The sole and exclusive indicator of the scope of the implementations, and what is intended by the applicants to be the scope of the implementations, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further including,” in the foregoing description or following claims, what follows this phrase can be an additional step or entity, or a sub-step/sub-entity of a previously-recited step or entity.

1. A method for generating a token on a blockchain, the method comprising:
causing an execution of one or more functions of a smart contract, wherein the smart contract is associated with a first token of the blockchain,
wherein the first token comprises data associating the first token with:
a first data element corresponding to a first non-physical element of a physical asset,
a first visualization corresponding to the first data element;
a second data element corresponding to a second non-physical element of the physical asset, and
a second visualization corresponding to the second data element;
wherein the execution of the one or more functions of the smart contract causes:
the generation of a second token of the blockchain, the second token comprising data associating the second token with the second data element corresponding to the second non-physical element of the physical asset and the second visualization corresponding to the second data element;
the generation of data detaching the association of the first token with the second data element corresponding to the second non-physical element of the physical asset and the second visualization corresponding to the second data element.

2. The method of claim 1, wherein the first token includes at least one metadata field comprising a URI (uniform resource indicator) referencing the first data element corresponding to the first non-physical element of the physical asset.

3. The method of claim 1, wherein the first token includes at least one metadata field comprising a URI (uniform resource indicator) referencing the first visualization corresponding to the first data element.

4. The method of claim 1, wherein the generated data detaching the association of the first token with the second data element and the second visualization is added to a block of the blockchain.

5. The method of claim 1, comprising causing the second token to be transferred to a wallet address of the blockchain different from the wallet address possessing the first token.

6. The method of claim 1, further comprising controlling access to one or more data elements associated with a token on a blockchain, which comprising:
receiving a request to access data representing a non-physical element of a physical asset;
identifying, on the blockchain, a token comprising an association with the data representing the non-physical element of the physical asset;
identifying a public cryptographic key of an entity that made the request;
using the public cryptographic key to verify that the entity that made the request possesses the token; and
granting access to the data representing the non-physical element of the physical asset.

7. The method of claim 6, wherein using the public cryptographic key to verify that the entity that made the request possesses the token comprises:
identifying a wallet address that possesses the token, and
using the public cryptographic key to verify a digital signature associated with the wallet address.

8-17. (canceled)

18. A computer program product for generating a token on a blockchain comprising a non-transitory machine-readable medium storing instructions that, when executed by at least one programmable processor, cause the at least one programmable processor to perform operations comprising:
causing an execution of one or more functions of a smart contract, wherein the smart contract is associated with a first token of the blockchain,
wherein the first token comprises data associating the first token with:
a first data element corresponding to a first non-physical element of a physical asset,
a first visualization corresponding to the first data element;
a second data element corresponding to a second non-physical element of the physical asset, and
a second visualization corresponding to the second data element;
wherein the execution of the one or more functions of the smart contract causes:
the generation of a second token of the blockchain, the second token comprising data associating the second token with the second data element corresponding to the second non-physical element of the physical asset and the second visualization corresponding to the second data element;
the generation of data detaching the association of the first token with the second data element corresponding to the second non-physical element of the physical asset and the second visualization corresponding to the second data element.

19. The computer program product of claim 18, wherein the first token includes at least one metadata field comprising a URI (uniform resource indicator) referencing the first data element corresponding to the first non-physical element of the physical asset.

20. The computer program product of claim 18, wherein the first token includes at least one metadata field comprising a URI (uniform resource indicator) referencing the first visualization corresponding to the first data element.

21. The computer program product of claim 18, wherein the generation of the data detaching the association of the first token with the second data element and the second visualization comprises adding the data to a block of the blockchain.

22. The computer program product of claim 18, wherein the operations further comprise causing the second token to be transferred to a wallet address of the blockchain that is different from a wallet address possessing the first token.

23. The computer program product of claim 18, wherein the operations further comprise controlling access to one or more data elements associated with a token on a blockchain wherein the operations further comprise:
receiving a request to access data representing a non-physical element of a physical asset;
identifying, on the blockchain, a token comprising an association with the data representing the non-physical element of the physical asset;
identifying a public cryptographic key of an entity that made the request;
using the public cryptographic key to verify that the entity that made the request possesses the token; and
granting access to the data representing the non-physical element of the physical asset.

24. The computer program product of claim 23, wherein using the public cryptographic key to verify that the entity possesses the token comprises:
identifying a wallet address that possesses the token, and
using the public cryptographic key to verify a digital signature associated with the wallet address.

25-34. (canceled)

35. A system for generating a token on a blockchain comprising:
at least one programmable processor; and
a non-transient machine-readable medium storing instructions that, when executed by the processor, cause the at least one programmable processor to perform operations comprising:
causing an execution of one or more functions of a smart contract, wherein the smart contract is associated with a first token of the blockchain,
wherein the first token comprises data associating the first token with:
a first data element corresponding to a first non-physical element of a physical asset,
a first visualization corresponding to the first data element;
a second data element corresponding to a second non-physical element of the physical asset, and
a second visualization corresponding to the second data element;
wherein the execution of the one or more functions of the smart contract causes:
the generation of a second token of the blockchain, the second token comprising data associating the second token with the second data element corresponding to the second non-physical element of the physical asset and the second visualization corresponding to the second data element;
the generation of data detaching the association of the first token with the second data element corresponding to the second non-physical element of the physical asset and the second visualization corresponding to the second data element.

36. The system of claim 35, wherein the first token includes at least one metadata field comprising a Uniform Resource Identifier (URI) referencing the first data element.

37. The system of claim 35, wherein the first token includes at least one metadata field comprising a Uniform Resource Identifier (URI) referencing the first visualization.

38. The system of claim 35, wherein the generated data detaching the association of the first token with the second data element and the second visualization is added to a block of the blockchain.

39. The system of claim 35, wherein the operations further comprise causing the second token to be transferred to a wallet address of the blockchain that is different from a wallet address possessing the first token.

40. The system of claim 35, wherein the operations further comprise controlling access to one or more data elements associated with a token on a blockchain, which comprising:
receiving a request to access data representing a non-physical element of a physical asset;
identifying, on the blockchain, a token comprising an association with the data representing the non-physical element of the physical asset;
identifying a public cryptographic key of an entity that made the request;
using the public cryptographic key to verify that the entity that made the request possesses the token; and
granting access to the data representing the non-physical element of the physical asset.

41-60. (canceled)
